(19) United States
(12) Patent Application Publication
(10) Pub. No.: US 2018/0009319 A1
(43) Pub. Date: Jan. 11, 2018

(54) CONTROL DEVICE

(71) Applicant: DENSO CORPORATION, Kariya-city, Aichi-pref. (JP)

(72) Inventors: Tsubasa SAKUISHI, Kariya-city (JP); Masakazu YAMAMOTO, Kariya-city (JP)

(73) Assignee: DENSO CORPORATION, Kariya-city, Aichi-pref. (JP)

(21) Appl. No.: 15/550,061

(22) PCT Filed: Mar. 8, 2016
(86) PCT No.: PCT/JP2016/001239

§ 371 Date: Aug. 10, 2017

(30) Foreign Application Priority Data
Mar. 24, 2015 (JP) 2015-061533

(51) Int. Cl. B60L 3/08; B60L 3/12

(52) U.S. Cl. CPC B60L 3/08; B60L 3/12

(57) ABSTRACT

When an acceleration degree of a vehicle in a state of an electric motor generating torque as motive power is small compared to the acceleration degree of the vehicle in a state of being propelled using that torque, a user is notified by displaying a warning on a display which is a notification device of the vehicle.

### CROSS REFERENCE TO RELATED APPLICATIONS

The present application is based on Japanese patent application No. 2015-61533 filed on Mar. 24, 2015, the content of which is incorporated herein by reference.

### TECHNICAL FIELD

The present disclosure relates to a control device of a vehicle which is propelled using motive power generated by an electric motor.

### BACKGROUND ART

In recent years, due to factors such as increased environmental awareness, there is an increase in the adoption of vehicles equipped with electric motors for propulsion. In such vehicles, in addition to those which are propelled solely by motive power generated from electric motors, there are so-called hybrid automobiles which are propelled by appropriately using motive power generated from electric motors and internal combustion engines.

Typically, sound generated from the operation of electric motors or inverters are quieter than sound generated from the operation of internal combustion engines. Accordingly, when a vehicle is only operating an electric motor, there is a concern that pedestrians may not notice the vehicle, which may lead to dangers such as collision.

The following Patent Literature 1 describes a vehicle which aims to solve the above described issue by adjusting the sound generated from the operation of an inverter. Specifically, according to this vehicle, the switching frequency of the inverter is adjusted to be an audible frequency prior to departure. As a result, nearby pedestrians are informed of the vehicle's departure, and accidents may be prevented.

### PRIOR ART LITERATURES

### Patent Literature

Patent Literature 1: JP 2010-93908 A

### SUMMARY

However, for a vehicle equipped with an electric motor, in addition to nearby pedestrians, there is a concern that the above described sound characteristics may present dangers to a user of the vehicle as well. For example, when the user presses down on the accelerator pedal to try to depart with the vehicle, in some cases the vehicle may not be able to climb over a level difference. In those cases, if the user further presses down on the accelerator pedal to try to climb over the level difference, an excess amount of motive force may be generated. As a result, after climbing over the level difference, the vehicle may suddenly take off.

When a vehicle uses an internal combustion engine to generate the necessary motive power for departure, a significant amount of sound is generated from the internal combustion engine as the accelerator pedal is pressed. Accordingly, it is relatively easy for a user to recognize the danger of a sudden acceleration. However, when a vehicle uses only an electric motor to generate the necessary motive power for departure, even if a significant amount of motive power is generated from the electric motor as the accelerator pedal is pressed, there is almost no difference in the sound generated. Accordingly, it may be difficult for the user to recognize that there is a danger of the vehicle suddenly taking off.

In view of the above topics, it is an object of the present disclosure to provide a control device of a vehicle which operates using motive power generated by an electric motor, where the control device is able to inform a user of a danger of the vehicle suddenly taking off.

A control device according to the present disclosure for a vehicle which is propelled using motive power generated by an electric motor includes an acceleration request detection unit that detects an acceleration request from a user, an acceleration detection unit that detects an acceleration degree of the vehicle, and a motive power detection unit that detects a motive power generated by the electric motor in accordance with the acceleration request. When the acceleration degree of the vehicle in a state of the electric motor generating the motive power is small compared to the acceleration degree of the vehicle in a state of being propelled using that motive power, the user is notified by operating a notification device of the vehicle.

According to the present disclosure, when the electric motor is generating motive power and the acceleration degree of the vehicle during this state is low compared to the acceleration degree of the vehicle being propelled using this motive power, the notification device of the vehicle is operated to notify the user. Accordingly, when the vehicle is unable to overcome a level difference etc. and is unable to take off, and so the motive power generated by the electric motor becomes excessively high while the vehicle is not accelerating, the user is notified. Due to this, the user may recognize that there is a danger of the vehicle suddenly taking off, and may avoid a sudden take off.

According to the present disclosure, a control device of a vehicle which operates using motive power generated by an electric motor, where the control device is able to inform a user of a danger of the vehicle suddenly taking off, may be provided.

### BRIEF DESCRIPTION OF DRAWINGS

FIG. 1 is a schematic view of an electric vehicle mounted with a control device according to a first embodiment of the present disclosure.

FIG. 2 is a block diagram showing a control device of FIG. 1.

FIG. 3 is a flowchart showing a process flow of a control device of FIG. 1.

FIG. 4 is a time chart showing an example of a control by a control device of FIG. 1.

FIG. 5 is a flow chart showing a process flow of a control device according to a second embodiment of the present disclosure.

FIG. 6 is time chart showing an example of a control by a control device according to a second embodiment of the present disclosure.

### DESCRIPTION OF EMBODIMENTS

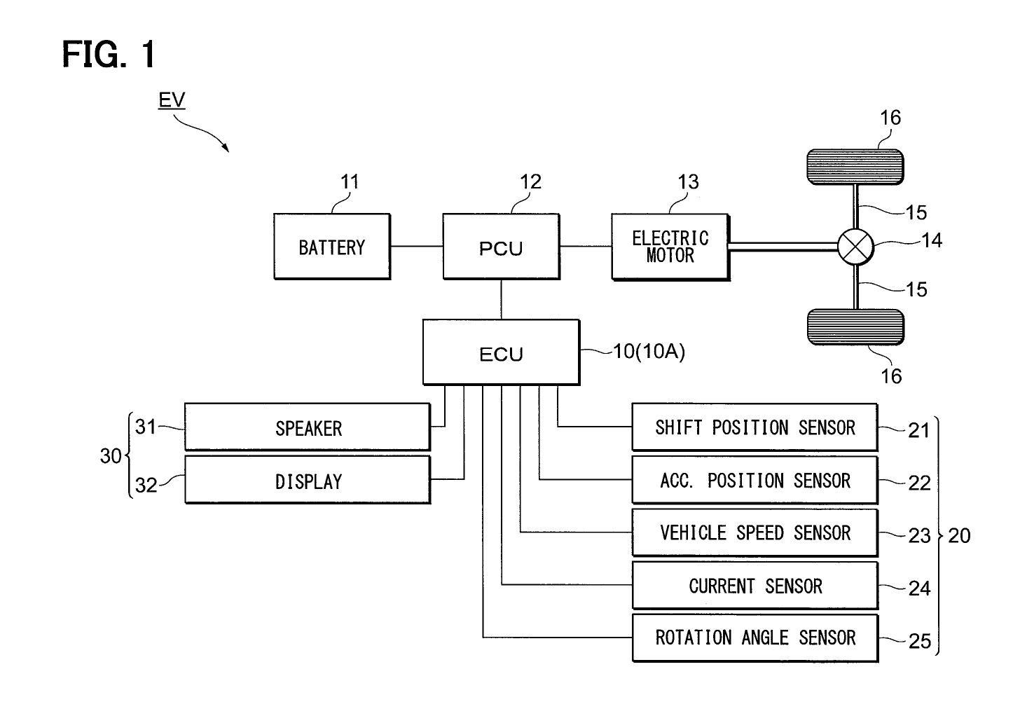

First, a first embodiment of the present disclosure will be explained with reference to FIGS. 1 to 4. For ease of understanding, the same reference numerals will be used for the same elements in each figure where possible, and overlapping explanations will be omitted for brevity.

First, an electric vehicle EV (hereafter, simply referred to as a “vehicle EV”) will be explained with reference to FIG. 1. The vehicle EV includes an ECU 10, a battery 11, a PCU 12, an electric motor 13, a differential 14, drive shafts 15, 15, wheels 16, 16, various sensors 20, and a notification device 30.

The ECU (Electronic Control Unit) 10 is an electronic device equipped with a plurality of microcomputers (not illustrated). The ECU 10 is electrically connected to, and configured to communicate with, the PCU 12, the various sensors 20, and the notification device 30. Further, in the present application, the term “electrically connected” is not limited to a wired connection, but includes wireless communication as well.

The battery 11 is configured as a combination of a plurality of individual batteries (not illustrated). The battery 11 is a rechargeable battery, and is capable of both charging and discharging.

The PCU (Power Control Unit) 12 is electrically connected to the ECU 10, the battery 11, and the electric motor 13. The PCU 10 controls the charging and discharging of the battery 11 based on control signals received from the ECU 10. Further, the PCU 10 includes converter functionalities including boosting direct current power and converting direct current power into alternating current power.

The electric motor 13 is electrically connected to the PCU 12. The electric motor 13 is an electric motor operated by three-phase alternating current power supplied from the PCU 12.

The various sensors 20 includes a shift position sensor 21, an accelerator position sensor 22, a vehicle speed sensor 23, a current sensor 24, and a rotation angle sensor 25. The shift position sensor 21 is a sensor that determines the position of a shift lever (not illustrated) of the vehicle EV, such as “P” (parking), “R” (reverse), and “D” (drive). The accelerator position sensor 22 is a sensor that detects an accelerator position representing an amount by which an accelerator pedal (not illustrated) of the vehicle EV is depressed. The vehicle speed sensor 23 is a sensor for detecting a speed of the vehicle EV (hereinafter referred to as “vehicle speed”). Here, “vehicle speed” refers to the movement speed of the vehicle EV with respect to the road surface. The current sensor 24 is a sensor that detects a current supplied to the electric motor 13. The rotation angle sensor 25 includes an encoder and a Hall element (neither illustrated), and is a sensor that detects a rotation angle of a rotor (not illustrated) of the electric motor 13. The various sensors 20 produce detection signals corresponding to their respective detection information, and sends the detection signals to the ECU 10.

The notification device 30 includes a speaker 31 and a display 32. The speaker 31 is a device which outputs a voice or a warning sound toward the passenger cabin of the vehicle EV. The speaker 31 is configured with an adjustable volume. The display 32 is a liquid display panel disposed in an instrument panel of the vehicle EV. The display 32 is configured to display various information.

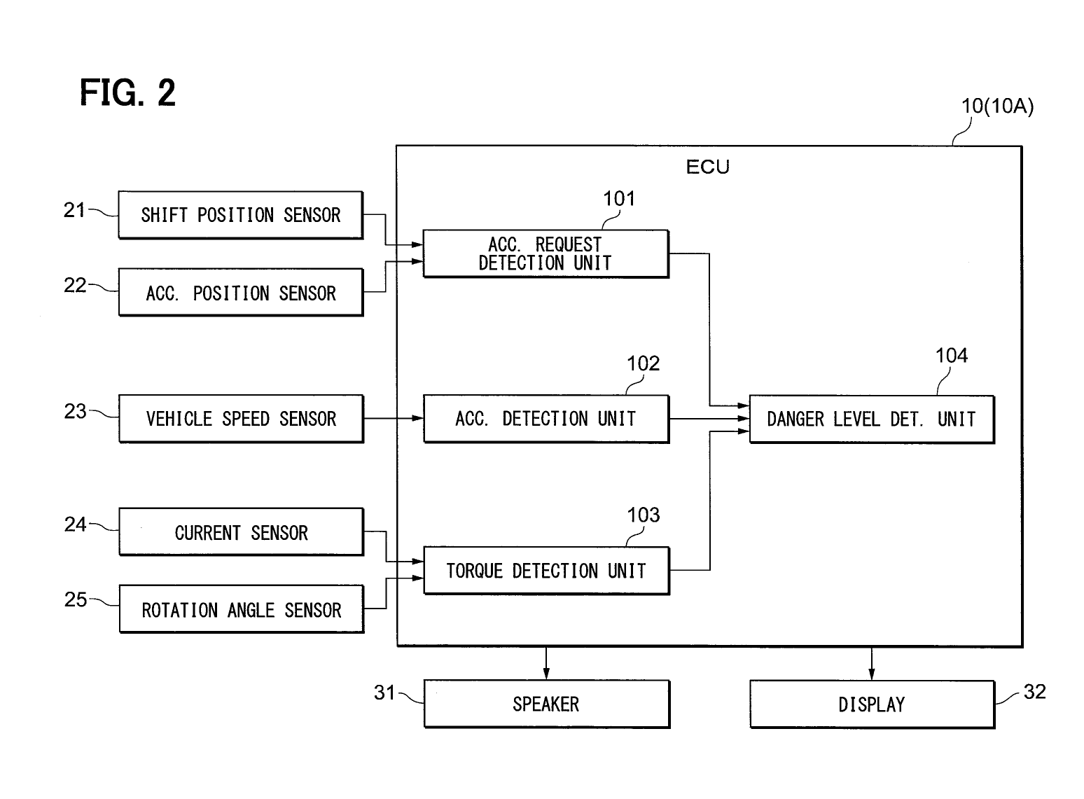

Next, the ECU 10 will be explained with reference to FIG. 2. A portion of the ECU 10 or the entirety of the ECU 10 is configured from analog circuits or digital processors including memory. FIG. 2 shows the ECU 10 as a functional control block diagram. Further, the software modules included in the analog circuits or digital processors of the ECU 10 are not necessarily separated into the control blocks shown in FIG. 2. In other words, a software module may correspond to a plurality of control blocks, or may be a further subdivision of the control blocks. As long as the following process flows may be performed, the internal configuration of the ECU 10 may be adjusted as appropriate by a skilled person.

As shown in FIG. 2, the ECU 10 includes an acceleration request detection unit 101, an acceleration detection unit 102, a torque detection unit 103, and a danger level determination unit 104.

The acceleration request detection unit 101 is a portion that detects an acceleration request based on a detection signal received from the shift position sensor 21 and the accelerator position sensor 22. The acceleration request is a degree of acceleration requested by the user for the vehicle EV. In other words, when the shift position sensor 21 detects that the shift lever is in the “D” (drive) position, as the accelerator opening degree detected by the accelerator position sensor 22 is bigger, the acceleration request is bigger. The ECU 10 sends a control signal to the PCU 12 such that the electric motor 13 generates a torque (motive power) corresponding to this acceleration request.

The PCU 12, which receives the control signal sent from the ECU 10, causes the battery 11 to electrically discharge, converts to alternating current power, and then supplies the alternating current power to the electric motor 13 to operate the electric motor 13. The torque generated from the electric motor 13 operating is transmitted to the wheels 16, 16 through the differential 14 and the drive shafts 15, 15, and the wheels 16, 16 are rotated to cause the vehicle EV to travel.

The acceleration detection unit 102 is a portion that detects an acceleration degree of the vehicle EV based on the detection signal received from the vehicle speed sensor 23. Specifically, the acceleration detection unit 102 calculates the vehicle speed of the vehicle EV based on the signal received from the vehicle speed sensor 23, then detects the acceleration degree of the vehicle EV by time differentiating this vehicle speed.

The torque detection unit 103 is a portion that detects the torque generated by the electric motor 13 based on the detection signal received from the current sensor 24 and the rotation angle sensor 25.

The danger level determination unit 104 is a portion which determines a danger level of the vehicle EV suddenly taking off based on the acceleration request calculated by the acceleration request detection unit 101, the acceleration degree of the vehicle EV detected by the acceleration detection unit 102, and the torque of the electric motor 13 detected by the torque detection unit 103. As described later, the danger level determination unit 104 determines that there is a danger of the vehicle EV suddenly taking off when the torque generated by the electric motor 13 is excessive with respect to the acceleration degree of the vehicle EV.

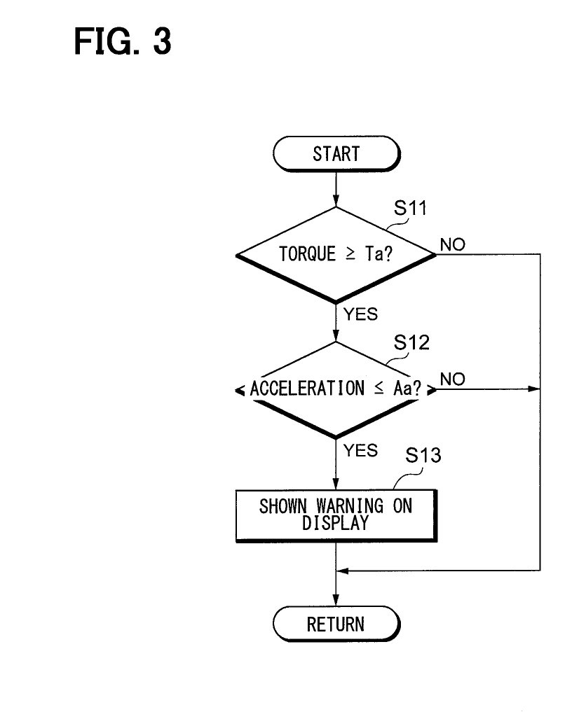

Next, with respect to FIG. 3, the flow of a process performed by the ECU 10 as configured above will be explained. Next, to simplify the following explanation, even for processes which are specifically performed by the various portions of the ECU 10 such as the acceleration request detection unit 101, these processes will be broadly described as being performed by the ECU 10.

Further, at step S11 shown in FIG. 3, the ECU 10 determines whether the torque generated by the electric motor 13 is equal to or greater than a threshold Ta. The threshold Ta is a predetermined value. When it is determined that the torque generated by the electric motor 13 is not equal to or greater than the threshold Ta (S11: NO), the ECU 10 terminates the process. Conversely, when it is determined that the torque generated by the electric motor 13 is equal to or greater than the threshold Ta (S11: YES), the ECU 10 continues to the processing of step S12.

First, at step S12, the ECU 10 determines whether the acceleration degree of the vehicle EV is equal to or below a threshold Aa. The threshold Aa is a predetermined value. Further, the threshold Aa is a value where if the electric motor 13 generates a torque equal to or above the threshold Ta, the acceleration degree of vehicle EV when travelling using this torque should exceed the threshold Aa. When it is determined that the acceleration degree of the vehicle EV exceeds the threshold Aa (S12: NO), the ECU 10 determines that the vehicle EV is accelerating appropriately with respect to the torque generated by the electric motor 13, and terminates the process. Conversely, when it is determined that the acceleration degree of the vehicle EV is equal to or less than the threshold Aa (S12: YES), the ECU 10 determines that the vehicle EV is not accelerating according to the torque generated by the electric motor 13, and continues to the processing of step S13.

Next at step S13, the ECU 10 causes the display 32 is display a warning to the user. Specifically, the ECU 10 causes the display 32 to display that the torque generated by the electric motor 13 is excessive with respect to the actual acceleration degree of the vehicle EV, and so there is a concern of the vehicle EV suddenly taking off. With this display, the user may recognize that there is a concern of the vehicle EV suddenly taking off. Accordingly, the user may easy off on pressing down on the accelerator pedal to reduce the torque generated by the electric motor 13, and thereby may avoid the vehicle EV suddenly taking off.

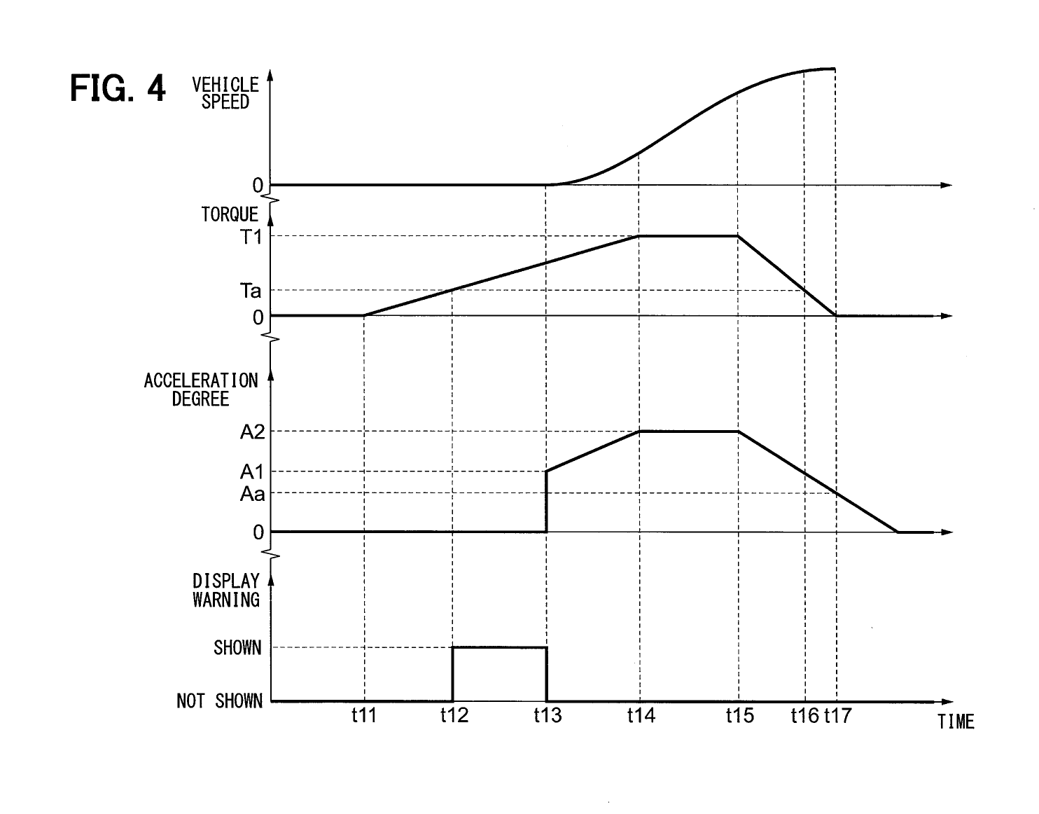

Next, with respect to FIG. 4, an example of a control by the ECU 10 will be explained.

When the vehicle EV is stopped still, the user begins pressing down on the accelerator pedal at time t11 shown in FIG. 4. Then, electric power is supplied from the battery 11 to the electric motor 13, and the electric motor 13 generates torque. As the acceleration opening degree increases, the torque generated by the electric motor 13 increases.

Here, when for example the vehicle EV encounters a level difference which it is unable to climb over, the vehicle speed and the acceleration degree of the vehicle EV is zero. To climb over the level difference, the user further presses down on the accelerator pedal, and the torque generated by the electric motor 13 increases while the acceleration degree of the vehicle EV remains at zero.

At time t12, the torque generated by the electric motor 13 is equal to or greater than the threshold Ta. At this time, the vehicle EV has not climbed over the level difference, and the vehicle speed and acceleration degree remain at zero. Since the torque generated by the electric motor 13 is equal to or greater than the threshold Ta, and the acceleration degree of the vehicle EV is equal to or less than the threshold Aa, based on this, the ECU 10 notifies the user with the display 32. In other words, the user is informed that there is a danger of the vehicle EV suddenly taking off. Due to this display, the user recognizes the danger of the vehicle EV suddenly taking off, and may easy off on pressing down on the accelerator pedal to reduce the torque generated by the electric motor 13, and thereby may avoid the vehicle EV suddenly taking off.

Assuming that the user does not ease off on pressing the accelerator pedal, then at time t13 when the vehicle EV climbs over the level difference, the vehicle speed begins to increase, and since the acceleration degree is at A1 which is greater than the threshold Aa, the vehicle EV suddenly takes off. While the torque generated by the electric motor 13 is equal to or greater than the threshold Ta, the acceleration degree of the vehicle EV is also greater than the threshold Aa, so the ECU 10 stops displaying the warning to the user with the display 32.

Next, the torque generated by the electric motor 13 is at its maximum value of T1 between time t14 and time t15, and decreases to the threshold Ta at time t16, but during this period the acceleration degree of the vehicle EV remains greater than the threshold Aa. Accordingly, from time t13 to time t16, the ECU 10 does not display the warning to the user with the display 32.

Then, the acceleration degree of the vehicle EV is equal to or less than the threshold Aa at time 17, but at this time the torque generated by the electric motor 13 is already equal to or less than the threshold Ta, so from time t16 to time t17 as well, the ECU 10 does not display the warning to the user with the display 32.

Further, according to the first embodiment, when the torque generated by the electric motor 13 is equal to or greater than the predetermined threshold Ta and the acceleration degree of the vehicle EV is equal to or lower than the predetermined threshold Aa, the display 32 displays a warning to the user. However, the present disclosure is not limited to this embodiment. For example, the threshold Aa for the acceleration degree of the vehicle EV may be adjusted according to the value of the torque generated by the electric motor 13.

Due to the above, when the electric motor 13 is generating torque and the acceleration degree of the vehicle EV during this state is low compared to the acceleration degree of the vehicle EV in a state of traveling using this torque, the ECU 10 uses the display 32 of the vehicle EV to display a warning to the user to notify the user. Accordingly, when the vehicle EV is unable to overcome a level difference etc. and is unable to take off, and so the torque generated by the electric motor 13 becomes excessively high while the vehicle EV is not accelerating, the ECU 10 notifies the user. Due to this, the user may recognize that there is a danger of the vehicle EV suddenly taking off, and may avoid a sudden take off.

Further, the ECU 10 uses the display 32 to display a warning to the user when the torque generated by the electric motor 13 is equal to or greater than the predetermined threshold Ta and the acceleration degree of the vehicle EV is equal to or less than the predetermined threshold Aa. Due to this, the processing by the ECU 10 may be simplified, while still only notifying the user by the display 32 when there is a danger of the vehicle EV suddenly taking off.

In addition, the display 32 may display a higher notification level when the torque generated by the electric motor 13 is high as compared to when this torque is low. In other words, when the torque generated by the electric motor 13 is high, the color or the display range of the warning shown on the display 32 may be difference as compared to when this torque is low. As a result, the user may more strongly recognize the danger of the vehicle EV suddenly taking off.

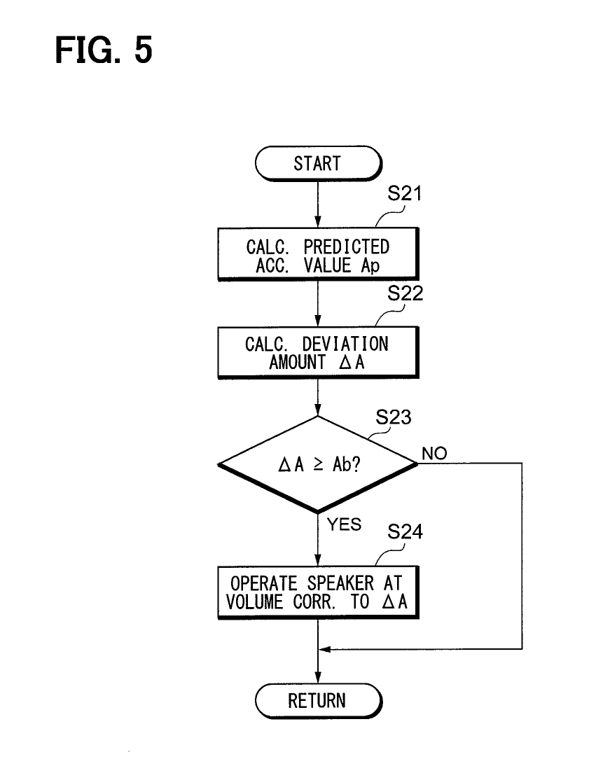

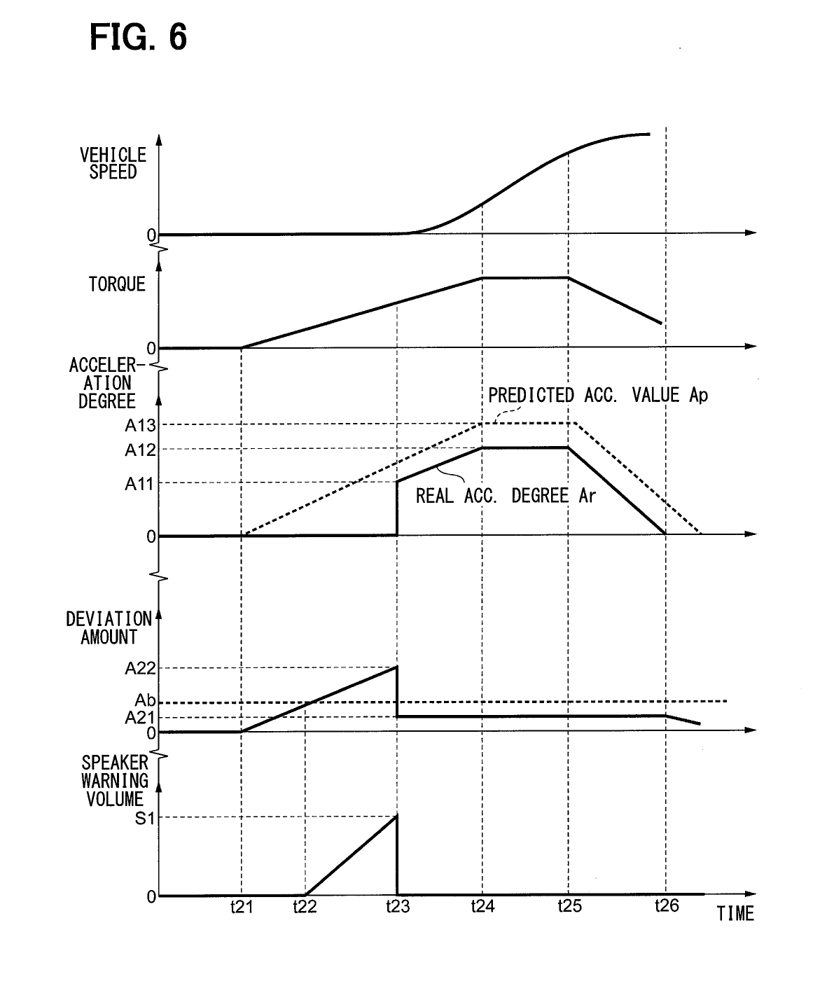

Next, with reference to FIGS. 5 and 6, a second embodiment of the present disclosure will be explained. An ECU 10A (refer to FIGS. 1 and 2) according to the second embodiment, similar to the ECU 10 according to the first embodiment, is an electronic device mountable on a vehicle EV. The ECU 10A differs from the ECU 10 in the method of calculating a danger of the vehicle EV suddenly taking off, and in the method of notifying regarding that danger. In accordance with this, configurations of the second embodiment which are common with those of the aforementioned first embodiment will be denoted with the same reference numerals, and explanations thereof are omitted for brevity.

First, at step S21 shown in FIG. 5, the ECU 10A calculates a predicted acceleration value Ap of the vehicle EV. This predicted acceleration value Ap may be calculated based on the torque value generated by the electric motor 13 and the weight of the vehicle EV.

In addition, the predicted acceleration value Ap may be more accurately calculated by considering the gravity applied to the vehicle EV and the slope of the road surface that the vehicle EV is on. In other words, when the vehicle EV is on an upward sloped road surface, the horizontal component of gravity with respect to the road surface applied to the vehicle EV hinders the acceleration of the vehicle EV in the forward direction. Further, when the vehicle EV is on a downward sloped road surface, the horizontal component of gravity with respect to the road surface applied to the vehicle EV promotes the acceleration of the vehicle EV in the forward direction.

Next, at step S22, the ECU 10A calculates a deviation amount ΔA. The deviation amount ΔA is a difference between the predicted acceleration value Ap calculated at step S21, and a real acceleration degree Ar which is the actual acceleration degree of the vehicle EV.

Next, at step S23, the ECU 10A determines whether the deviation amount ΔA is equal to or greater than a threshold Ab. When it is determined that the deviation amount ΔA is not equal to or greater than the threshold Ab (S23: NO), i.e., when the vehicle EV is appropriately accelerating according to the torque generated by the electric motor 13, the ECU 10A terminates the process. Conversely, when is determined that the deviation amount ΔA is equal to or greater than the threshold Ab (S23: YES), i.e., when the vehicle EV is not appropriately accelerating according to the torque generated by the electric motor 13, the ECU 10A continues to the processing of step S24.

Next, at step S24, the ECU 10A operates the speaker 31. At this time, the volume of a warning sound from the speaker 31 corresponds to the size of the deviation amount ΔA, such that the greater the deviation amount ΔA, the greater the volume of the warning sound. Upon hearing this warning sound, the user may recognize that there is a danger of the vehicle EV suddenly taking off. As a result, the user may ease off on pressing the accelerator pedal, reduce the torque generated by the electric motor 13, and avoid the vehicle EV suddenly taking off.

Next, an example control of the ECU 10 will be explained with reference to FIG. 6.

When the vehicle EV is stopped still, the user begins pressing down on the accelerator pedal at time t21 shown in FIG. 6. Then, electric power is supplied from the battery 11 to the electric motor 13, and the electric motor 13 generates torque. As the acceleration opening degree increases, the torque generated by the electric motor 13 increases.

As the torque generated from the electric motor 13 increases, the predicted acceleration value Ap calculated by the ECU 10A also increases. However, when for example the vehicle EV encounters a level difference which it is unable to climb over, the vehicle speed and the real acceleration degree Ar of the vehicle EV is zero, and the deviation amount ΔA is produced. To climb over the level difference, the user further presses down on the accelerator pedal, and the torque generated by the electric motor 13 and the deviation amount ΔA increase while the acceleration degree of the vehicle EV remains at zero.

At time t22, the deviation amount ΔA is equal to or greater than the threshold Tb. At this time, the vehicle EV has not climbed over the level difference, and the vehicle speed and real acceleration degree Ar remain at zero. Since the deviation amount user ΔA is equal to or greater than the threshold Tb, based on this, the ECU 10A operates the speaker 31 to produce the warning sound. The warning sound becomes louder as the deviation amount ΔA increases. Due to hearing this warning sound, the user recognizes the danger of the vehicle EV suddenly taking off, and may easy off on pressing down on the accelerator pedal to reduce the torque generated by the electric motor 13, and thereby may avoid the suddenly taking off.

Assuming that the user does not ease off on pressing the accelerator pedal, then at time t23 when the vehicle EV climbs over the level difference, the real acceleration degree Ar increases. Due to this, the deviation amount ΔA decreases to A21 which is lower than the threshold Ab, and so the ECU 10A stops the operation of the speaker 31.

Next, the vehicle EV accelerates according to the torque generated by the electric motor 13, and from time t23 to time t26, the deviation amount ΔA remains at A21 which is smaller than the threshold Ab. Accordingly, from time t23 to time t26, the ECU 10A does not operate the speaker 31 to generate the warning sound.

As described above, the ECU 10A sets the notification to be higher when the deviation amount ΔA is greater. The deviation amount ΔA is between the real acceleration degree Ar of the vehicle EV and the predicted acceleration value Ap calculated based on the torque generated by the electric motor 13. In other words, when the deviation amount ΔA is large, the volume of the warning sound produced from the speaker 31 is high. Due to this, when there is a danger of the vehicle EV suddenly taking off, a notification corresponding to this danger level may be provided to the user.

Above, a plurality of embodiments of the present disclosure are described with reference to specific examples. However, the present disclosure is not limited to these specific examples. In other words, these specific examples may be appropriately modified by a skilled person without changing the gist of the present disclosure as long as the features of the present disclosure are included. The present disclosure is not limited to the various elements described with respect to the specific examples, not the placement, material, conditions, shapes, or sizes thereof, any of which may be appropriately modified.

1. A control device for a vehicle which is propelled using motive power generated by an electric motor, comprising:
an acceleration request detection unit that detects an acceleration request from a user;
an acceleration detection unit that detects an acceleration degree of the vehicle; and
a motive power detection unit that detects a motive power generated by the electric motor in accordance with the acceleration request, wherein
when the acceleration degree of the vehicle in a state of the electric motor generating the motive power is small compared to the acceleration degree of the vehicle in a state of being propelled using that motive power, the user is notified by operating a notification device of the vehicle.

2. The control device of claim 1, wherein
the notification device is operated when the motive power generated by the electric motor is equal to or greater than a predetermined particular motive power and the acceleration degree of the vehicle is equal to or less than a predetermined particular acceleration degree.

3. The control device of claim 1, wherein
a notification level of the notification device is increased when the motive power generated by the electric motor is large as compared to when this motive power is small.

4. The control device of claim 1, wherein
a notification level of the notification device is increased when a deviation amount is large as compared to when this deviation amount is small, the deviation amount being between the acceleration degree of the vehicle and a predicted acceleration value calculated based on the motive power generated by the electric motor.
